(19) United States
(12) Patent Application Publication
(10) Pub. No.: US 2017/0124401 A1
(43) Pub. Date: May 4, 2017

(54) SYSTEM AND METHOD FOR SEARCHING LOCATION OF OBJECT

(71) Applicant: SAMSUNG SDS CO., LTD., Seoul (KR)

(72) Inventors: Sung-Hoon CHOI, Seoul (KR); Jong-Eun LEE, Seoul (KR); Ju-Dong KIM, Seoul (KR)

(73) Assignee: SAMSUNG SDS CO., LTD., Seoul (KR)

(21) Appl. No.: 14/980,618

(22) Filed: Dec. 28, 2015

(30) Foreign Application Priority Data
Oct. 29, 2015 (KR) 10-2015-0151040

(51) Int. Cl. G06K 9/00; H04N 5/225; G06T 7/20; G06K 9/62

(52) U.S. Cl. CPC G06K 9/00785; G06K 9/6215; H04N 5/2252; G06T 7/20

(57) ABSTRACT

A system and method for searching for a position of an object are provided. The system includes an image matching unit configured to extract a path from a map indicating a target region, and match a node present in the path and a captured image obtained by a capturing device installed at a position corresponding to the node; a path synthesis unit configured to synthesize the path in the captured image; and an object search unit configured to receive an estimated path of a target object and information related to an exposure direction in an image from a user, and select one or more among a plurality of capturing devices installed in the target region using the received information and the captured image.

### CROSS-REFERENCE TO RELATED APPLICATION

This application claims priority to and the benefit of Korean Patent Application No. 10-2015-0151040, filed on Oct. 29, 2015, the disclosure of which is incorporated herein by reference in its entirety.

### BACKGROUND

1. Field

Exemplary embodiments of the present disclosure relate to a technique of searching for and tracking a position of an object using an image.

2. Discussion of Related Art

Recently, image monitoring technology of searching for and tracking a target object using position information of a camera installed in a target region has been widely used in order to prevent crimes and accidents and solve them. According to the image monitoring technology, cameras installed at a distance close to a desired search position based on the position information of the cameras can be automatically recommended to a user.

However, the conventional image monitoring technology has a problem in which quality and reliability of information deteriorate since only position information of a camera is considered when recommending the camera for searching for a target object. As one example, even when the camera is installed at a distance close to the desired search position but a region captured by a corresponding camera is not a region which a user wants to see (that is, when a capturing direction of the camera is not a direction which the user wants to capture), the target object may not be included in a captured image captured by the corresponding camera. Further, even when a camera is installed at a distance far away from the desired search position but the region captured by the corresponding camera is a region which the user wants to see (that is, when a capturing direction is the direction in which the user wants to capture), the corresponding camera should be recommended to the user, but according to the conventional art, the camera is excluded from a recommended target.

Further, the conventional image monitoring technology may not identify the target object included in the captured image even when the target object is included in the captured image since an installation angle or direction of a camera is not considered when recommending the camera. As an example, when the target object is A (a person), the captured image does not help to identify the person A since the captured image includes only the back side of the person A even when the person A is included in the captured image of the camera recommended for the user.

For this reason, the conventional technology cannot help in searching for the target object while the user visually confirms the captured images captured by a plurality of capturing devices one by one.

### SUMMARY

The present disclosure is directed to a means for effectively searching for a target object by considering an installation position and an installation angle (or a capturing direction) of a capturing device.

According to one aspect of the present disclosure, there is provided a system for searching for a position of an object, including: an image matching unit configured to extract a path from a map indicating a target region, and match a node present in the path and a captured image obtained by a capturing device installed at a position corresponding to the node; a path synthesis unit configured to synthesize the path in the captured image; and an object search unit configured to receive an estimated path of a target object and information related to an exposure direction in an image from a user, and select one or more among a plurality of capturing devices installed in the target region using the received information and the captured image.

The object search unit may compare the path synthesized in the captured image and the estimated path, collect a list of the capturing devices installed in the estimated path, and select the capturing device capturing the exposure direction among the capturing devices included in the list.

The object search unit may select the capturing device by considering a size or a position of the target object in the captured image obtained by the capturing device capturing the exposure direction when there are a plurality of capturing devices capturing the exposure direction.

The object search unit may receive information related to a path start point and a path end point in the target region from the user, and generate the estimated path based on the path start point and the path end point.

The system for searching for the position of the object may further include: a display unit configured to display the captured image captured by the selected capturing device.

The system for searching for the position of the object may further include: a path correction unit configured to extract moving trajectories of objects included in the obtained captured image, compare a moving trajectory and the path, and determine whether an installation angle of the capturing device is changed.

The path correction unit may correct a direction of the path as a direction of the moving trajectory when it is determined that the installation angle of the capturing device is changed.

According to another aspect of the present disclosure, there is provided a method for searching for a position of an object, including: extracting a path from a map indicating a target region, by an image matching unit; matching a node present in the path and a captured image obtained by a capturing device installed at a position corresponding to the node, by the image matching unit; synthesizing the path in the captured image, by a path synthesis unit; receiving an estimated path of a target object and information related to an exposure direction in an image from a user, by an object search unit; and selecting one or more among a plurality of capturing devices installed in the target region using the received information and the captured image, by the object search unit.

The selecting of one or more among the plurality of capturing devices installed in the target region may include comparing the path synthesized in the captured image and the estimated path, collecting a list of the capturing devices installed in the estimated path, and selecting the capturing device capturing the exposure direction among the capturing devices included in the list.

The selecting of one or more among the plurality of capturing devices installed in the target region may include selecting the capturing device by considering a size or a position of the target object in the captured image obtained by the capturing device capturing the exposure direction when there are a plurality of capturing devices capturing the exposure direction.

The estimated path may be generated based on information related to a path start point and a path end point in the target region input from the user.

The method for searching for the position of the object may further include: displaying a captured image captured by the selected capturing device, by a display unit.

The method for searching for the position of the object may further include: extracting moving trajectories of objects included in the obtained captured image, by a path correction unit; and comparing a moving trajectory and the path, and determining whether an installation angle of the capturing device is changed, by the path correction unit.

The method for searching for the position of the object may further include: correcting a direction of the path as a direction of the moving trajectory when it is determined that the installation angle of the capturing device is changed, by the path correction unit.

According to still another aspect of the present disclosure, there is provided a computer program stored in a computer-readable recording medium for executing a method in combination with hardware, the method including: extracting a path from a map indicating a target region, by an image matching unit; matching a node present in the path and a captured image obtained by a capturing device installed at a position corresponding to the node, by the image matching unit; synthesizing the path in the captured image, by a path synthesis unit; receiving an estimated path of a target object and information related to an exposure direction in an image from a user, by an object search unit; and selecting one or more among a plurality of capturing devices installed in the target region using the received information and the captured image, by the object search unit.

### BRIEF DESCRIPTION OF THE DRAWINGS

The above and other objects, features, and advantages of the present disclosure will become more apparent to those of ordinary skill in the art by describing in detail exemplary embodiments thereof with reference to the accompanying drawings, in which:

FIG. 1 is a block diagram illustrating a detailed configuration of a system for searching for a position of an object according to an exemplary embodiment of the present disclosure;

FIG. 2 is a diagram for describing an operation of extracting a path by an image matching unit according to an exemplary embodiment of the present disclosure;

FIG. 3 is a diagram illustrating an operation of matching a node present in a path and a captured image by an image matching unit according to an exemplary embodiment of the present disclosure;

FIG. 4 is a diagram illustrating a state in which a path is synthesized in the captured image according to an exemplary embodiment of the present disclosure;

FIG. 5 is a diagram illustrating a search condition of an object input to an object search unit by a user according to an exemplary embodiment of the present disclosure;

FIG. 6 is a diagram illustrating an exposure direction of a target object included in a captured image according to an exemplary embodiment of the present disclosure;

FIG. 7 is a diagram for comparing a capturing device selected according to an exemplary embodiment of the present disclosure and a capturing device selected according to the conventional art;

FIG. 8 is a diagram for describing an operation of displaying a captured image by a display unit according to an exemplary embodiment of the present disclosure;

FIG. 9 is a diagram for describing an operation of extracting moving trajectories of objects by a path correction unit according to an exemplary embodiment of the present disclosure;

FIG. 10 is a diagram for describing an operation of determining whether an installation angle of a capturing device is changed by a path correction unit according to an exemplary embodiment of the present disclosure; and

FIG. 11 is a flowchart for describing a method of searching for a position of an object according to an exemplary embodiment of the present disclosure.

### DETAILED DESCRIPTION OF EXEMPLARY EMBODIMENTS

Hereinafter, exemplary embodiments of the present disclosure will be described with references to the accompanying drawings. The following description is provided in order to provide a comprehensive understanding with respect to a method, apparatus, and/or system described herein. However, this is merely for illustrative purposes, and the present disclosure is not limited thereto.

In the following descriptions of exemplary embodiments of the present disclosure, when it is determined that a detailed description of a well-known technology related to the present disclosure can unnecessarily obscure a subject matter of the present disclosure, the description will be omitted. All terms used herein are terms defined by considering functions in the present disclosure, and may be different according to intentions or customs of a user, or an operator. Accordingly, the terms should be defined based on the description in this specification. The terms used herein are only for describing exemplary embodiments according to the present disclosure, and should not be interpreted as being restrictive. Unless otherwise defined, the use of the singular form in the present document should not preclude the presence of more than one referent. It will be further understood that the terms “comprises,” “comprising,” “includes,” and/or “including,” when used herein, specify the presence of stated features, items, steps, operations, elements, or components or a part or combinations thereof, but do not preclude the presence or addition of one or more other features, items, steps, operations, elements, components, or a part or combinations thereof.

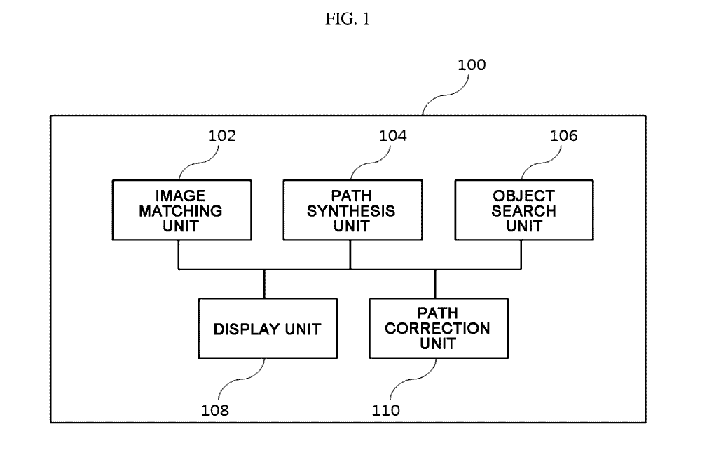

FIG. 1 is a block diagram illustrating a detailed configuration of a system for searching for a position of an object 100 according to an exemplary embodiment of the present disclosure. As shown in FIG. 1, the system for searching for a position of an object 100 according to an exemplary embodiment of the present disclosure may include an image matching unit 102, a path synthesis unit 104, an object search unit 106, a display unit 108, and a path correction unit 110.

The image matching unit 102 may extract a path from a map indicating a target region, and match a node present in the extracted path and a captured image obtained by a capturing device installed in a position corresponding to the node. Here, the target region may be a region which is a search target, and include an interior region such as the inside of a department store, the inside of a building as well as an outside region such as a driveway, a sidewalk, buildings, geographic terrain, etc. in a broad sense. A plurality of capturing devices (not shown) may be installed at predetermined intervals in the target region. For example, the capturing device may be a camera, a camcorder, etc., and capture a portion of the target region. An installation position, an installation angle (or a capturing direction), a specification, etc. installed in the target region may be different according to each of the capturing devices. Further, in the exemplary embodiments which will be described hereinafter, the path may refer to a road on which a person or a transportation means (for example, a vehicle, a motorcycle, etc.) in which the person rides goes.

First, the image matching unit 102 may extract the path from the map indicating the target region. For example, the image matching unit 102 may determine that a portion in which the geographic terrain is not indicated on the map is the path. However, the method in which the image matching unit 102 extracts the path from the map is not limited thereto, and for example, the image matching unit 102 may extract the path on the map by matching pattern information which is prestored with respect to the driveway, the sidewalk, etc.

Next, the image matching unit 102 may match a node present in the extracted path and the captured image obtained by the capturing device installed in a position corresponding to the node. For this, the image matching unit 102 may obtain the captured image displayed on a corresponding capturing device based on the installation position, the installation angle (or the capturing direction), the specification, etc. of the capturing device installed in the position corresponding to each node. Further, the image matching unit 102 may receive the captured image captured by the corresponding capturing device from the capturing device installed in the position corresponding to each node. For example, the image matching unit 102 may project the captured image on the map, and match the node and the captured image by three-dimensionally adjusting a position or size of the map or the captured image according to the input of the user (or, a manager). Further, for example, the image matching unit 102 may match the node and the captured image by adjusting the installation position, the installation angle, etc. which are stored inside according to the input of the user.

Through the above operation, the user may confirm the captured image at a position of the intersection on the map, that is, each node, and thus recognize any position on the map captured by each capturing device. Further, the user may easily recognize information regarding where the object within the captured image comes from, or where the object within the captured image is headed for.

The path synthesis unit 104 may synthesize the path extracted by the image matching unit 102 in the captured image obtained by the capturing device. In detail, the path synthesis unit 104 may synthesize each path in the captured image based on the information matched by the image matching unit 102. Since each node generated by the image matching unit 102 is matched with the captured image obtained by the capturing device installed at the position corresponding to a corresponding node, the path synthesis unit 104 may obtain direction information in the captured image based on the matched information, and determine whether a corresponding direction corresponds to any path among the paths extracted by the image matching unit 102. Accordingly, the path synthesis unit 104 may synthesize the path extracted by the image matching unit 102 in the captured image obtained by the capturing device, and the user may easily obtain information indicating that the path extracted from the map corresponds to any path in the captured image.

Meanwhile, in exemplary embodiments of the present disclosure, it is assumed that each node is matched with one or more capturing devices and the captured image obtained by the capturing device. When the capturing device is present at a position between the nodes generated by the image matching unit 102, the image matching unit 102 may generate a new node at a position on the map corresponding to the position in which the capturing device is installed, and match the generated node with the capturing device. Accordingly, when following the path generated by the image matching unit 102, the user may identify the capturing device capturing the node on a corresponding path, and easily recognize the capturing direction of the capturing device capturing the node. Accordingly, the user may intuitively recognize the moving path of the target object in the captured image, and recognize a next capturing device to be confirmed according to the moving path.

The object search unit 106 may select the capturing device for searching for the target object according to a search condition input from the user. For this, first, the object search unit 106 may receive information related to an estimated path of the target object and an exposure direction in the image from the user.

The information related to the estimated path may be information used for estimating the moving path of the target object in the target region, and for example, may be information related to a path start point and a path end point of the target object in the target region. As one example, the object search unit 106 may receive the information related to the path start point and the path end point of the target object in the target region from the user, and generate one or more estimated paths of the target object based on the path start point and the path end point. For example, the estimated path may be a path in which the path start point and the path end point are connected.

Further, the information related to the exposure direction may be information regarding any direction in which the target object is exposed in the image captured by the capturing device, and for example, may indicate that the front side of the target object is exposed on the image, the back side of the target object is exposed, the left side is exposed, or the right side is exposed, etc. The information related to the exposure direction may be different according to a type of the desired search target object. As one example, when the target object is a person, since it is important to confirm a face of the person in the image, the user may input the front side of the target object as the exposure direction. As another example, when the target object is a vehicle, since it is important to confirm a license plate of the vehicle in the image, the user may input the front side or the back side of the target object as the exposure direction.

Next, the object search unit 106 may select one or more among the plurality of capturing devices installed in the target region using the search condition input by the user and the captured image described above. In detail, the object search unit 106 may compare the path synthesized in the captured image and the estimated path, collect a list of the capturing devices installed in the estimated path, and select the capturing device capturing the exposure direction input by the user among the capturing devices included in the list. The object search unit 106 may recognize an entry path and an exit path of the target object of each captured image, and determine whether any side (the front side, the back side, the left side, or the right side, etc.) of the target object is exposed.

When there are a plurality of capturing devices capturing the exposure direction, the object search unit 106 may select the capturing device by considering the size or the position of the target object in the captured image obtained by the capturing device capturing the exposure direction. That is, the object search unit 106 may change a priority of the capturing devices to be selected according to the size or the position of the target object in the captured image obtained by the capturing device capturing the exposure direction.

As one example, the object search unit 106 may select the captured image in which the target object is displayed to have the greatest size among the captured images obtained by the capturing devices capturing the exposure direction, and preferentially select the capturing device corresponding to the selected captured image as the capturing device for searching for the object. As another example, the object search unit 106 may select the captured image in which the target object is located in a lower portion of the image among the captured images obtained by the capturing device capturing the exposure direction, and preferentially select the capturing device corresponding to the selected captured image as the capturing device for searching for the object. Accordingly, the user may rapidly recognize what the most helpful capturing device among the plurality of capturing devices installed in the target region is when searching for the target object, and thus a search time of the target object may be reduced.

The display unit 108 may display the captured image obtained by the capturing device installed in the target region. In this case, the display unit 108 may display the captured image in which the path and the node generated by the image matching unit 102 are synthesized. The path and the node may be displayed based on identification information of the path and the node. The identification information of the path and the node may be information indicating whether the path and the node correspond to any path and position on the map, and for example, may be indicated by a combination of one or more characters or numbers. The user may intuitively confirm the path in the corresponding captured image through the image displayed by the display unit 108. Further, the display unit 108 may display the captured image in which the position of the capturing device installed in the target region is displayed. In this case, the user may input one position in the captured image through an input device (not shown), and the display unit 108 may display the path of the corresponding position and the capturing device installed in the path.

Further, the display unit 108 may selectively display the captured image obtained by the capturing device selected by the object search unit 106 by interworking with the object search unit 106. As described above, the object search unit 106 may obtain information related to the most helpful capturing device when searching for the target object according to the search condition input by the user, and the display unit 108 may display the captured image obtained by the capturing device selected by the object search unit 106 to the user. As described above, the selected captured image may include the target object, and the user may easily search for the target object through the captured image.

The path correction unit 110 may correct the path generated by the image matching unit 102. When the installation angle of the capturing device is changed from an initial installation angle for the reason of management of the capturing device, etc. (for example, a check of the capturing device, when a road extended in both directions is changed to a one-way direction, etc.), since the path in the captured image and the path of the inside of the system do not match, reliability on a search result of the target object may deteriorate.

In order to solve the problem, the path correction unit 110 may determine whether the installation angle (or the installation direction) of the capturing device is changed compared with a previous angle using the moving trajectories of objects included in the captured image obtained by the capturing device, and correct the path generated by the image matching unit 102 according to the determination result.

For this, first, the path correction unit 110 may extract the moving trajectories of the objects included in the captured image for determining whether the installation angle of the capturing device is changed. As one example, the path correction unit 110 may compare a difference image between a current frame and a previous frame, extract a portion in which a change in the captured image is generated, determine a movement of the object, and extract the moving trajectories of the objects in the target region by matching the difference image of next frames of the captured image and a template after configuring the portion in which the change is generated as the template having a predetermined size (for example, 16×16 pixels). The path correction unit 110 may accumulate the moving trajectories of the objects by repeatedly performing the operation during a predetermined time, divide into a portion in which the moving trajectory is generated and a portion in which the moving trajectory is not generated by analyzing the number and the direction of the accumulated moving trajectories, and extract a main direction of the moving trajectory in the portion in which the moving trajectory is generated.

Next, the path correction unit 110 may compare the extracted moving trajectory (or the main direction of the moving path) and the path generated by the image matching unit 102, and determine whether the installation angle of the capturing device is changed. When the moving trajectory extracted by the path correction unit 110 and the path generated by the image matching unit 102 do not match, the path correction unit 110 may determine that the installation angle of the capturing device is changed.

When it is determined that the installation angle of the capturing device is changed, the path correction unit 110 may correct the direction of the path generated by the image matching unit 102 as the direction of the moving trajectory. That is, according to exemplary embodiments of the present disclosure, whether the installation angle of the capturing device is changed may be determined, the information related to the corresponding capturing device may be corrected by the image matching unit 102 according to the determination result, and thus the search accuracy of the target object may be prevented from decreasing due to the change of the installation angle of the capturing device.

In an exemplary embodiment, the image matching unit 102, the path synthesis unit 104, the object search unit 106, the display unit 108, and the path correction unit 110 may be implemented in a computing device including one or more processors and a computer-readable recording (storage) medium connected to the processors. The computer-readable recording (storage) medium may be located inside or outside the processors, and may be connected to the processors by various means which are well known. The processor inside the computing device may allow each computing device to operate according to an exemplary embodiment which will be described herein. For example, the processor may execute instructions stored in the computer-readable recording (storage) medium, and when the instructions stored in the computer-readable recording (storage) medium are executed by the processor, the processor may be configured to allow the computing device to operate according to an exemplary embodiment which will be described herein.

The above modules of the system for searching for a position of an object 100 may be implemented with hardware. For example, the system for searching for a position of an object 100 may be implemented or included in a computing apparatus. The computing apparatus may include at least one processor and a computer-readable storage medium such as a memory that is accessible by the processor. The computer-readable storage medium may be disposed inside or outside the processor, and may be connected with the processor using well known means. A computer executable instruction for controlling the computing apparatus may be stored in the computer-readable storage medium. The processor may execute an instruction stored in the computer-readable storage medium. When the instruction is executed by the processor, the instruction may allow the processor to perform an operation according to an example embodiment. In addition, the computing apparatus may further include an interface device configured to support input/output and/or communication between the computing apparatus and at least one external device, and may be connected with an external device (for example, a device in which a system that provides a service or solution and records log data regarding a system connection is implemented). Furthermore, the computing apparatus may further include various different components (for example, an input device and/or an output device), and the interface device may provide an interface for the components. Examples of the input device include a pointing device such as a mouse, a keyboard, a touch sensing input device, and a voice input device, such as a microphone. Examples of the output device include a display device, a printer, a speaker, and/or a network card. Thus, the image matching unit 102, the path synthesis unit 104, the object search unit 106, the display unit 108, and the path correction unit 110 of the system for searching for a position of an object 100 may be implemented as hardware of the above-described computing apparatus.

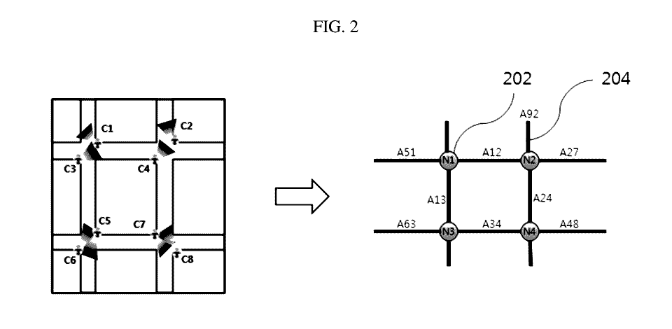

FIG. 2 is a diagram for describing an operation of extracting a path by the image matching unit 102 according to an exemplary embodiment of the present disclosure. As described above, the image matching unit 102 may extract a path 204 from the map indicating the target region. As shown in FIG. 2, the map may be a two-dimensional map indicating the target region on a plane. However, it is not limited thereto, and the map may be a three-dimensional map which three-dimensionally indicates the target region. The map may indicate a plurality of capturing devices C1 to C8 installed in the target region in addition to the geographic terrain of the target region. The image matching unit 102 may analyze the map, and extract the path 204. For example, the image matching unit 102 may determine that a portion in which the geographic terrain is not shown in the map is the path 204. Further, the image matching unit 102 may select the intersection on the extracted path as the node 202. For example, in FIG. 2, N1, N2, N3, and N4 may be nodes 202, and A12, A13, A24, A34, A27, A48, A51, A63, and A92 may be the paths 204. The image matching unit 102 may mutually match the intersection on the map and the node of the corresponding intersection. For example, the image matching unit 102 may mutually match the intersection in which the capturing devices C2 and C4 are located on the map and the node N2.

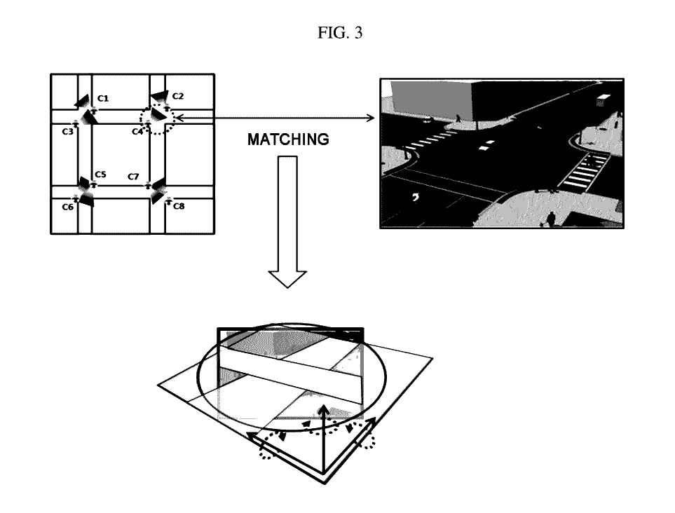

FIG. 3 is a diagram illustrating an operation of matching a node present in a path and a captured image by the image matching unit 102 according to an exemplary embodiment of the present disclosure. As described above, the image matching unit 102 may match the node present in the extracted path and the captured image obtained by the capturing device installed at a position corresponding to the node. As an example, as shown in FIG. 3, the image matching unit 102 may match the node N2 shown in FIG. 2 and the captured image obtained by the capturing device installed at the position corresponding to the node N2. For example, the image matching unit 102 may project the captured image on the map, and match the node and the captured image by three-dimensionally adjusting the position or the size of the map or the captured image according to the input of the user (or the manager).

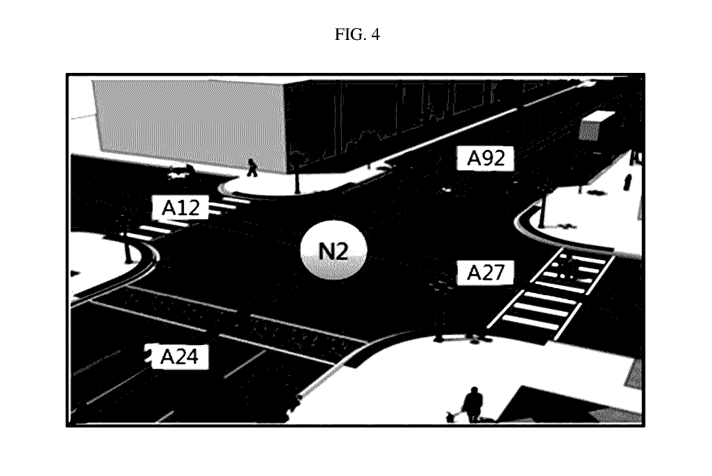

FIG. 4 is a diagram illustrating a state in which a path is synthesized in the captured image according to an exemplary embodiment of the present disclosure. As described above, the path synthesis unit 104 may synthesize the path generated by the image matching unit 102 in the captured image obtained by the capturing device. As an example, as shown in FIG. 4, the path synthesis unit 104 may synthesize each of the paths adjacent to the node N2, that is, A12, A27, A92, and A24, in the captured image obtained by the capturing device installed at the position corresponding to the node N2.

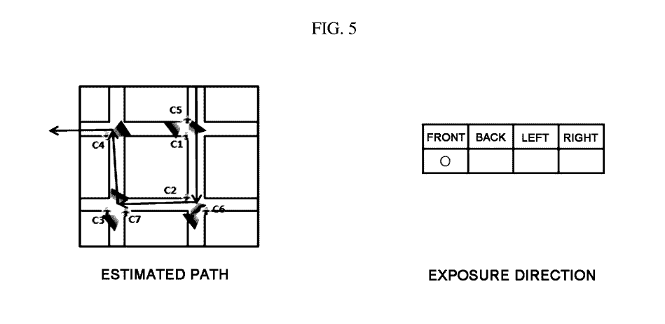

FIG. 5 is a diagram illustrating a search condition of an object input to the object search unit 106 by a user according to an exemplary embodiment of the present disclosure. As described above, the object search unit 106 may receive information related to the estimated path of the target object and the exposure direction in the image as the search condition of the target object from the user. For example, the information related to the estimated path may be information related to the path start point and the path end point of the target object in the target region. The object search unit 106 may receive information related to the path start point and the path end point of the target object in the target region from the user, and generate one or more estimated paths of the target object based on the path start point and the path end point.

Further, for example, the information related to the exposure direction may indicate that the front side of the target object is exposed, the back side of the target object is exposed, the left side of the target object is exposed, or the right side of the target object is exposed. The information related to the exposure direction may be changed according to the type of the desired search target object.

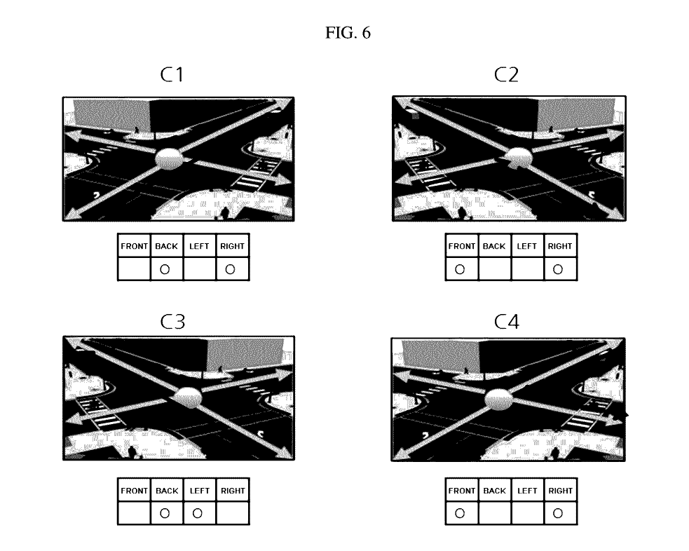

FIG. 6 is a diagram illustrating an exposure direction of a target object included in a captured image according to an exemplary embodiment of the present disclosure. The object search unit 106 may compare the path synthesized in the captured image and the estimated path shown in FIG. 5, collect a list of the capturing devices installed in the estimated path, and select the capturing device capturing the exposure direction input by the user among the capturing devices included in the list.

As an example, as shown in FIG. 6, assuming that the capturing devices C1 to C4 are installed in the estimated path of the target object, the back side and the right side of the target object may be exposed to the capturing device C1, the front side and the right side of the target object may be exposed to the capturing device C2, the back side and the left side of the target object may be exposed to the capturing device C3, and the front side and the right side of the target object may be exposed to the capturing device C4. When the exposure direction in the image of the target object input by the user is the front side, the object search unit 106 may select the capturing devices C2 and C4 capturing the front side of the target object.

Further, as described above, when there are a plurality of capturing devices capturing the exposure direction of the target object input by the user, the object search unit 106 may select the capturing device by considering the size or the position of the target object in the captured image obtained by the capturing device capturing the exposure direction. In the example described above, when the capturing devices C2 and C4 are capturing the exposure direction of the target object input by the user, the object search unit 106 may select one of the capturing devices C2 and C4 by considering the size or the position of the target object in the captured images obtained by the capturing devices C2 and C4.

For example, the object search unit 106 may select the captured image in which the target object is displayed to have the greatest size among the captured images obtained by the capturing devices capturing the exposure direction or the captured image in which the target object is located in a lower portion of the image, and select the capturing device corresponding to the selected captured image as the capturing device for searching for the object. In the example described above, since the target object in the captured image obtained by the capturing device C2 is relatively located in the lower portion of the image compared with the target object in the captured image obtained by the capturing device C4, the object search unit 106 may select the capturing device C2 as the capturing device for searching for the object.

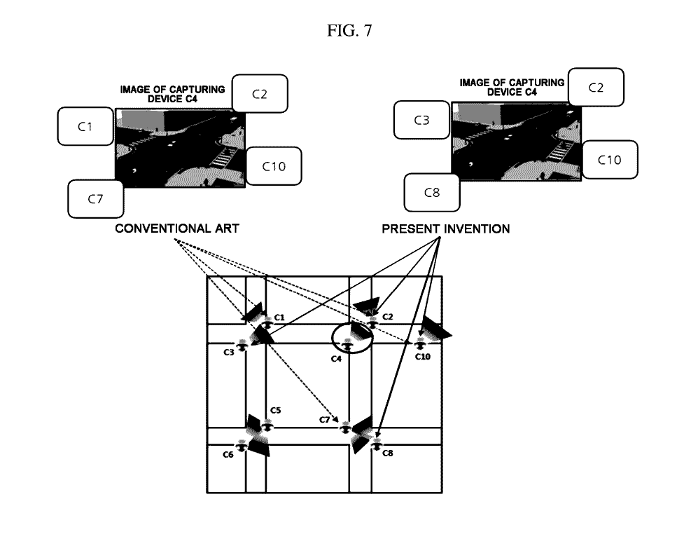

FIG. 7 is a diagram for comparing a capturing device selected according to an exemplary embodiment of the present disclosure and a capturing device selected according to the conventional art.

According to the conventional art, only the installation position of the capturing device may be considered in order to select the capturing device for searching for the target object. That is, according to the conventional art, the capturing devices C1, C2, C7, and C10 installed at the nearest distance from the capturing device C4 may be recommended for the user.

However, according to the present disclosure, in order to select the capturing device for searching for the target object, the captured image obtained by a corresponding capturing device, that is, the capturing direction of the capturing device, as well as the installation position of the capturing device may be considered. In the example described above, the capturing device C1 may be close to the capturing device C4 compared with the capturing device C3, but a center position of the captured image which is actually captured by the capturing device C1 may be far away from the capturing device C4 compared with a center position of the captured image which is actually captured by the capturing device C3. As described above, according to exemplary embodiments of the present disclosure, since the capturing device for searching for the target object is selected using the estimation information of the target object, the information related to the exposure direction in the image, and the captured image by the capturing device, the capturing devices C2, C3, C8, and C10 may be recommended for the user.

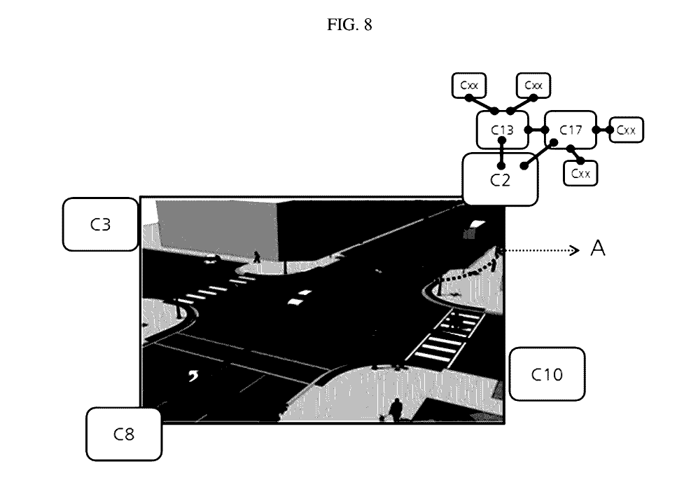

FIG. 8 is a diagram for describing an operation of displaying a captured image by the display unit 108 according to an exemplary embodiment of the present disclosure. As described above, the display unit 108 may display the captured image obtained by the capturing device installed in the target region. In this case, the display unit 108 may display the captured image in which the path and the node generated by the image matching unit 102 are synthesized. Further, the display unit 108 may display the captured image in which the position of the capturing device installed in the target region is shown. In this case, the user may input one position in the captured image through an input means (not shown), and in this case, the display unit 108 may display the path of a corresponding position and the capturing device installed in the path.

As one example, as shown in FIG. 8, the user may click or touch a portion A using the input means, and in this case, the display unit 108 may display the path of the portion A and the capturing device installed in the path. In this case, the display unit 108 may display the capturing device C13, C17, . . . , etc. adjacent to the capturing device C2 as well as the capturing device C2 installed in the portion A. Accordingly, the user may view the list of the capturing devices in which the target object is able to pass according to the movement of the target object in one glance.

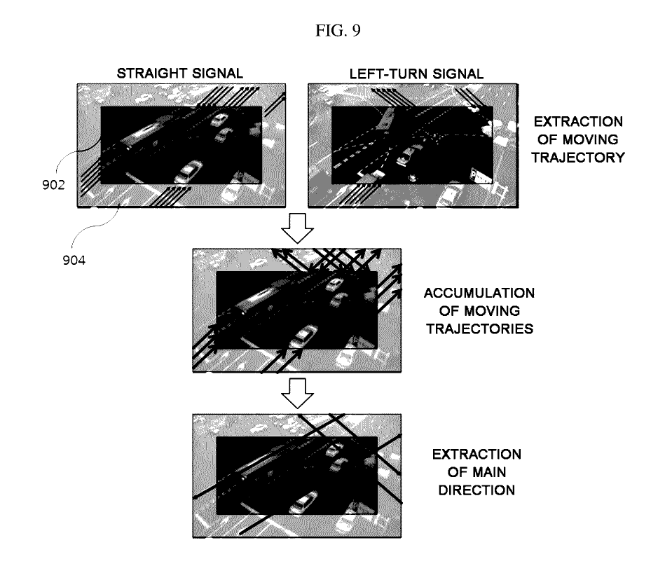

FIG. 9 is a diagram for describing an operation of extracting moving trajectories of objects by the path correction unit 110 according to an exemplary embodiment of the present disclosure. As described above, the path correction unit 110 may compare a difference image between a current frame and a previous frame of the captured image, extract a portion in which a change in the captured image is generated, determine the movement of the object, and extract the movement trajectories of the objects in the target region by matching the difference image of next frames of the captured image and the template after configuring the portion in which the change is generated as the template having the predetermined size (for example, 16×16 pixels).

As an example, as shown in FIG. 9, the path correction unit 110 may extract the moving trajectories of the objects in the captured image using the difference image described above in a boundary region 904 excluding a center region 902 in the captured image. The path correction unit 110 may improve an extraction speed of the moving trajectory by analyzing not all of the captured image but only the image in the boundary region 904. Assuming that the captured image shown in FIG. 9 indicates an intersection, the extracted moving trajectory may be different according to a signal (a go straight signal, a left-turn signal, etc.) of a traffic light at the intersection. The path correction unit 110 may accumulate the extracted moving trajectories, analyze the number of and the directions of the accumulated moving trajectories, divide into a portion in which the moving trajectory is generated and a portion in which the moving trajectory is not generated, and extract a main direction of the moving trajectory in the portion in which the moving trajectory is generated.

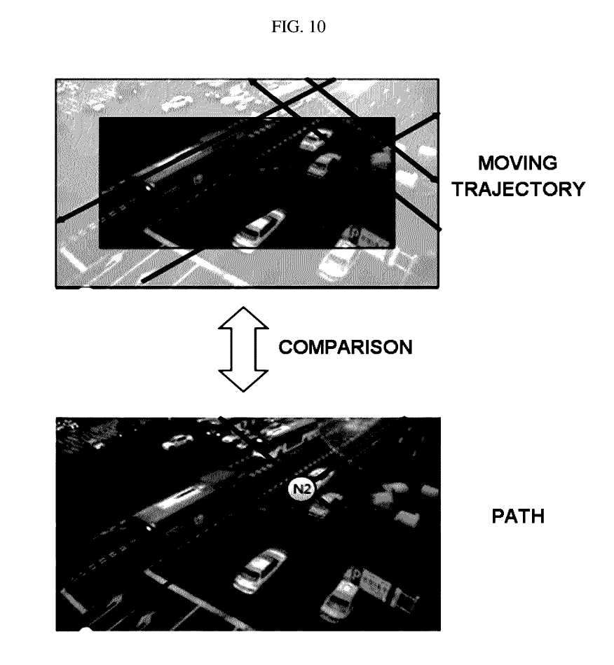

FIG. 10 is a diagram for describing an operating of determining whether an installation angle of a capturing device is changed by the path correction unit 110 according to an exemplary embodiment of the present disclosure. As shown in FIG. 10, the path correction unit 110 may compare the extracted moving trajectory and the path generated by the image matching unit 102, and determine whether the installation angle of the capturing device is changed. When the moving trajectory extracted by the path correction unit 110 and the path generated by the image matching unit 102 do not match, the path correction unit 110 may determine that the installation angle of the capturing device is changed. When it is determined that the installation angle of the capturing device is changed, the path correction unit 110 may correct the direction of the path generated by the image matching unit 102 as the direction of the moving trajectory.

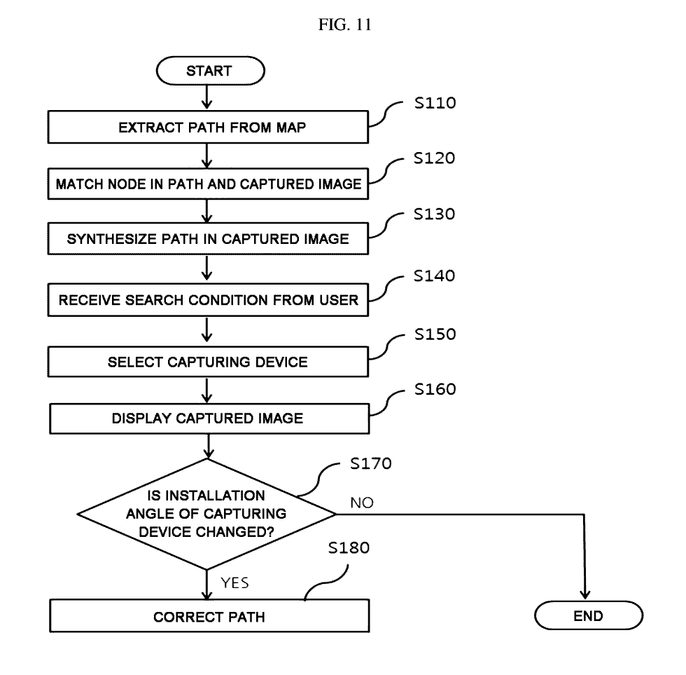

FIG. 11 is a flowchart for describing a method of searching for a position of an object according to an exemplary embodiment of the present disclosure. In the flowchart illustrated, the method is described by being divided into a plurality of operations, but at least one portion of the plurality of operations may be performed by changing the order, performed by being synthesized with another operation, omitted, performed by being divided into sub-operations, or performed by adding one or more operations which are not shown.

First, the image matching unit 102 may extract the path from the map indicating the target region (S110). For example, the image matching unit 102 may determine that the portion in which the geographic terrain is not shown in the map is the path.

Next, the image matching unit 102 may match the node present in the path and the captured image obtained by the capturing device installed in the position corresponding to the node (S120). For example, the image matching unit 102 may project the captured image on the map, and match the node and the captured image by three-dimensionally adjusting the position or the size of the map or the captured image according to the input of the user (or the manager).

Next, the path synthesis unit 104 may synthesize the path in the captured image (S130). The path synthesis unit 104 may synthesize each path in the captured image based on the information matched by the image matching unit 102.

Next, the object search unit 106 may receive the search condition for searching for the target object from the user (S140). For example, the search condition may be information related to the estimated path of the target object and the exposure direction in the image.

Next, the object search unit 106 may select one or more among the plurality of capturing devices installed in the target region according to the search condition (S150). In detail, the object search unit 106 may compare the path synthesized in the captured image and the estimated path, collect a list of the capturing devices installed in the estimated path, and select the capturing device capturing the exposure direction among the capturing devices included in the list.

Next, the display unit 108 may display the captured image captured by the selected capturing device (S160).

Next, the path correction unit 110 may extract the moving trajectories of the objects included in the obtained captured image, compare a moving trajectory and the path, and determine whether the installation angle of the capturing device is changed (S170).

When it is determined that the installation angle of the capturing device is changed in the operation S160, the path correction unit 110 may correct the direction of the path generated by the image matching unit 102 as the direction of the moving trajectory (S180).

Meanwhile, an exemplary embodiment of the present disclosure may include a program which is executable in a computer, and a computer-readable recording medium including the program. The computer-readable recording medium may include a program instruction, a local data file, a local data structure, etc. alone or in combination. The computer readable recording medium may be specially designed and configured for the present disclosure, or may be a medium which is generally used in the computer software field. Examples of the computer-readable recording medium may include a hard disk, a magnetic media such as a floppy disk and a magnetic tape, an optical recording media such as a compact disk-read only memory (CD-ROM) and a digital video disk (DVD), a magneto-optical media such as a floptical disk, and a hardware device which is specially configured to store and execute program instructions such as a ROM, a random access memory (RAM), a flash memory, etc. Examples of the program instructions may include not only machine code made by a compiler but also high-level language code which is executable by a computer using an interpreter, etc.

According to exemplary embodiments of the present disclosure, the quality and reliability of the information provided to the user can be improved by selecting the capturing device for searching for the target object using the installation position of the capturing device and the captured image obtained by the capturing device. Particularly, according to exemplary embodiments of the present disclosure, the capturing device may be selected based on the estimated path of the target object input by the user and the exposure direction required by the user, and the desired image of the user can be precisely and rapidly searched for by recommending the image including a better quality (by considering the size or the position of the target object in the captured image) among the captured images of the selected capturing device.

Further, according to exemplary embodiments of the present disclosure, the decrease of the search accuracy of the target object due to the change of the installation angle of the capturing device can be minimized by determining whether the installation angle of the capturing device is changed and correcting the information related to the corresponding capturing device by the image matching unit according to the determination result.

While the exemplary embodiments of the present disclosure are described in detail above, it will be understood by those of ordinary skill in the art that various changes and modifications in form and details may be made therein without departing from the spirit and scope as defined by the following claims. Accordingly, the scope of the present disclosure is not limited by the exemplary embodiments of the present disclosure, it is intended that the present disclosure covers all such modifications and changes of those of ordinary skill in the art derived from a basic concept of the appended claims, and their equivalents.

What is claimed is:

1. A system for searching for a position of an object, comprising:
an image matching unit configured to extract a path from a map indicating a target region, and match a node present in the path and a captured image obtained by a capturing device installed at a position corresponding to the node;
a path synthesis unit configured to synthesize the path in the captured image; and
an object search unit configured to receive an estimated path of a target object and information related to an exposure direction in an image from a user, and select one or more among a plurality of capturing devices installed in the target region using the received information and the captured image.

2. The system for searching for the position of the object of claim 1, wherein the object search unit compares the path synthesized in the captured image and the estimated path, collects a list of the capturing devices installed in the estimated path, and selects the capturing device capturing the exposure direction among the capturing devices included in the list.

3. The system for searching for the position of the object of claim 2, wherein the object search unit selects the capturing device by considering a size or a position of the target object in the captured image obtained by the capturing device capturing the exposure direction when there are a plurality of capturing devices capturing the exposure direction.

4. The system for searching for the position of the object of claim 2, wherein the object search unit receives information related to a path start point and a path end point in the target region from the user, and generates the estimated path based on the path start point and the path end point.

5. The system for searching for the position of the object of claim 1, further comprising:
a display unit configured to display the captured image captured by the selected capturing device.

6. The system for searching for the position of the object of claim 1, further comprising:
a path correction unit configured to extract moving trajectories of objects included in the obtained captured image, compare a moving trajectory and the path, and determine whether an installation angle of the capturing device is changed.

7. The system for searching for the position of the object of claim 6, wherein the path correction unit corrects a direction of the path as a direction of the moving trajectory when it is determined that the installation angle of the capturing device is changed.

8. A method for searching for a position of an object, comprising:
extracting a path from a map indicating a target region, by an image matching unit;
matching a node present in the path and a captured image obtained by a capturing device installed at a position corresponding to the node, by the image matching unit;
synthesizing the path in the captured image, by a path synthesis unit;
receiving an estimated path of a target object and information related to an exposure direction in an image from a user, by an object search unit; and
selecting one or more among a plurality of capturing devices installed in the target region using the received information and the captured image, by the object search unit.

9. The method for searching for the position of the object of claim 8, wherein the selecting of one or more among the plurality of capturing devices installed in the target region includes comparing the path synthesized in the captured image and the estimated path, collecting a list of the capturing devices installed in the estimated path, and selecting the capturing device capturing the exposure direction among the capturing devices included in the list.

10. The method for searching for the position of the object of claim 9, wherein the selecting of one or more among the plurality of capturing devices installed in the target region includes selecting the capturing device by considering a size or a position of the target object in the captured image obtained by the capturing device capturing the exposure direction when there are a plurality of capturing devices capturing the exposure direction.

11. The method for searching for the position of the object of claim 9, wherein the estimated path is generated based on information related to a path start point and a path end point in the target region input from the user.

12. The method for searching for the position of the object of claim 8, further comprising:
displaying a captured image captured by the selected capturing device, by a display unit.

13. The method for searching for the position of the object of claim 8, further comprising:
extracting moving trajectories of objects included in the obtained captured image, by a path correction unit; and
comparing a moving trajectory and the path, and determining whether an installation angle of the capturing device is changed, by the path correction unit.

14. The method for searching for the position of the object of claim 13, further comprising:
correcting a direction of the path as a direction of the moving trajectory when it is determined that the installation angle of the capturing device is changed, by the path correction unit.

15. A computer program stored in a computer-readable recording medium for executing a method in combination with hardware, the method comprising:
extracting a path from a map indicating a target region, by an image matching unit;
matching a node present in the path and a captured image obtained by a capturing device installed at a position corresponding to the node, by the image matching unit;
synthesizing the path in the captured image, by a path synthesis unit;
receiving an estimated path of a target object and information related to an exposure direction in an image from a user, by an object search unit; and
selecting one or more among a plurality of capturing devices installed in the target region using the received information and the captured image, by the object search unit.
